(19) United States
(12) Patent Application Publication
(10) Pub. No.: US 2013/0042508 A1
(43) Pub. Date: Feb. 21, 2013

(54) Personal Energy Greeting Card

(71) Applicant: Willard Alan Mayes, Dallas, TX (US)

(72) Inventor: Willard Alan Mayes, Dallas, TX (US)

(21) Appl. No.: 13/400,745

(22) Filed: Feb. 21, 2012

Related U.S. Application Data
(60) Provisional application No. 61/572,787, filed on Jul. 19, 2011.

(51) Int. Cl. G09F 1/00

(52) U.S. Cl. 40/124.01

(57) ABSTRACT

A greeting card or its accessory item includes means for micro-harvesting heat or kinetic energy from the living body of a human being or animal. This harvested energy powers one or more electronic components of the card or the accessory item. The sender of a personal energy greeting card is able to mark and personalize a greeting card with his or her own harvested energy, that of another person, or of a beloved animal, before sending the card to a recipient. The recipient experiences the personal energy when it is evinced through the greeting card's one or more integral or accessory electronic features. The sentimental impact of the various social expressions traditionally communicated through a greeting card is thus enhanced.

### BACKGROUND OF THE INVENTION

This invention relates to the enhancement of social expression products, in particular greeting cards; more particularly personalized conventional greeting cards. This invention adds a dynamic to physical greeting cards heretofore unknown in the art: intimate personalization through the inclusion of harvested personal energy. Personal energy is defined here as the energy naturally produced by the living body of a human being or animal.

This invention also relates generally to micro-energy harvesting from human or animal body sources to operate low-power electronic devices. Recent developments in micro-energy harvesting, power management and storage devices, especially in the thin-film area, make possible the unique application disclosed herein of this technology to the conventional greeting card genre.

Greeting cards have been a medium of social expression for centuries, remaining relevant over the years by adapting their content and designs to the times. Cards that have multiple folds and pop-out items, personal photographs, “scratch & sniff” pads, and electronic devices have all done well over the years to keep greeting cards modern, interesting and fashionable. Most recently, digital “e-card” greeting cards have become popular. Intangible computer creations, e-cards are delivered over a communications network and have a fantastic range of high quality photo, audio and video features to enhance the impact of the greetings they convey.

As a result, digital greeting cards have significantly challenged the conventional greeting card industry. Their popular, dynamic features have been difficult to match with a physical greeting card, and e-cards are generally more convenient and expeditious; they can be had on demand, customized, personalized and sent in a matter of minutes to dozens of recipients at once.

A more recent phenomenon of the digital age, social media, has made the digital challenge an existential one for the conventional greeting card industry. Not only do social media sites let members send dynamic e-card style social expression messages, but they also create an alternative social reality where all forms of social interaction online become more real and relevant to the sites' members than those in the physical world. And this alternative world has had its greatest appeal among one of the greeting card industry's most valuable demographics, the young.

In an article titled “Changing Demographics and Psychographics of the Greeting Card Market Reveal New Opportunities—and Challenges—for Card Marketers and Retailers” which was recently featured on the website of the market research firm Unity Marketing (www.unitymarketingonline.com), the largest, fastest growing and highest spending demographic of the greeting card market is identified as young people in the 25-34 age range. However, the article reports that this age group increasingly seeks out alternatives to traditional paper greeting cards and the preferred alternative is rapidly becoming social media. The report suggests that greeting card makers need to innovate in order to appeal to the new concepts that “alternative seekers” have for “communicating emotions to friends, relatives and others.”

Striving to do so, card makers have incorporated digital technology into their cards. Cards that incorporate miniature electronics, called “electronic greeting cards,” have become quite common in the industry. Electronic greeting cards play audio, put on a display of lights and/or feature animated parts that the recipient can enjoy by simply opening the card. Some allow senders to add personal recordings, voice or music. Recently, it has become feasible for physical greeting cards to include video recording and playing devices that add an audio-video dynamic to the genre. And in an effort to interface their cards with the popular internet, some card makers print a message in a selection of their cards that directs a purchaser or recipient to a website where he or she can experience web content that complements the theme or content of the card they've purchased.

As a further strategy for maintaining the appeal of their products, some greeting card makers have focused on the physical senses that e-cards cannot stimulate: feel, smell and taste. Textured cards, scented cards and cards that include a treat or can themselves be licked or eaten have no match in the digital world. Other greeting card makers have launched advertising campaigns that highlight the inimitable tangible nature of conventional paper greeting cards.

The present invention emphasizes another intrinsic quality exclusive to physical greeting cards that cannot be had in the digital realm: physical personalization. When the sender of a greeting card adds his or her own handwritten note, the impact of the card and its message is enhanced. To a recipient who shares an emotional bond with the sender, a card personalized in this way can seem to be marked with the sender's presence, a kind of personal energy left behind by the sender by merely handling the card and giving it his or her personal attention.

However, with the prior art of greeting cards, any such “personal energy' has had to be inferred. The recipient of a conventional greeting card has to impart the energy's intangible presence upon the card because the energy's reality is reliant upon the recipient believing that it exists and that through some sixth human sense he or she can experience it.

The invention of the present disclosure improves upon prior art by making it possible, through micro-energy harvesting technology, for the personal energy of a sender to be added to a greeting card in actuality, thereby enabling the sender to personalize a greeting card in an intimate manner heretofore not known. Instead of having to sense and infer the existence of the sender's personal energy, the recipient of a personal energy greeting card knows that the energy is truly present in the card (or its accessory) and he or she can in fact experience this energy when it is evinced through an electronic feature of the card or its accessory item.

There are many greeting card designs in prior art that include some kind of electronic component powered by batteries or other power sources, but no prior greeting card art harvests energy from the body of a person or animal, let alone with the intent of making this “personal energy” a feature of the card. The present invention therefore represents the introduction of a new class to the art of greeting cards: the personal energy greeting card.

There are also many various electronic devices that harvest energy from the body of a living human being or animal. However, all prior art in any and every field which harvests personal energy from the living bodies of humans or animals teaches doing so for a practical purpose: to use the harvested energy to power or augment the power to an electronic device. The harvested energy is treated no differently from any other source of electricity, as the purpose of the electronic device it powers is not to serve as a medium for the sharing of the personal energy but rather to accomplish a task that the device is separately designed to carry out and is able to complete with any suitable source of electrical power.

The present invention harvests personal energy for aesthetic purposes. In contrast to the intellectual, utilitarian approach of prior art, the present invention harvests personal energy to facilitate the communication of emotions and the arousal of sensations that possessing and being able to experience the personal energy of a significant other, even when he or she is not present, brings to the recipient of a personal energy greeting card; and the similar emotional satisfaction it gives the sender of a personal energy greeting card to share his or her personal energy with significant others. The present invention, therefore, represents not only a new class of greeting cards but also a new perspective on harvesting energy from human or animal sources and the intrinsic value of such personal energy.

In addition to enhancing the personal value of a greeting card, the method of sharing personal energy to personalize a greeting card taught by the present invention has the potential to boost the economic value of the physical greeting card industry at a time when the social relevance of its products is waning. Greeting card makers have reinforced the appeal of their cards by enhancing their designs and social expressions with digital elements. However, emulating the dynamic features of social media and e-cards does not play to two key strengths of traditional greeting cards: tangibility and personalization. And, it does not offer the consumer something that he or she can get only with a conventional greeting card. Offering today's generation of “alternative seekers” the same features that are available in the popular competing e-card and social media growth markets that are luring them away is not a long term winning strategy for the traditional greeting card industry.

In order to maintain its relevance in today's society, the physical greeting card industry certainly needs to develop products that embrace digital technology, but it must do this in a way that takes advantage of their cards' inherent strengths. It needs to offer unique digital features that do not exist and cannot be had in the social media realm.

### SUMMARY

Personal energy greeting cards have the potential to revitalize the traditional physical greeting card industry because they play to the strengths of traditional greeting cards—tangibility and personalization—in a new, unique and intimate way that the digital world of social media cannot match. The method and arrangements disclosed herein personalize a greeting card intimately, enhancing its intrinsic emotional value while complementing the card's design and/or social expression. Personal energy greeting cards offer the social expression industry an opportunity to go beyond playing catch up with the digital world of social media and forge ahead with its own new and exclusive “cool” electronic, digital feature.

The present invention utilizes an energy referred to here as “personal energy”, which is the energy produced naturally by the living body of a human being or animal, such as body heat or the kinetic energy of movement. It discloses a method that involves harvesting energy from the living body of a human being or animal, converting it to electrical energy, storing it in a battery, a capacitor, or other storage means as technology permits, and then using this stored personal energy as the source of electricity to power an electronic device that is an integral or accessory feature of a greeting card. Also disclosed is an alternative that involves the inclusion of an energy storage device charged with a store of personal energy in or with a greeting card, wherein the energy is harvested by means not integral to the card or its accessory.

“Personal energy” is added to a conventional greeting card or an item accessory to the card through an energy harvesting and storing apparatus integral to the card or its accessory item employing a process known as micro-energy harvesting. The energy is harvested and added to a greeting card or its accessory by generally one person, and the card is subsequently sent or given generally to another person. Some users may want to harvest the personal energy from an animal, such as a pet dog or cat.

The apparatus of the present invention generally comprises a micro-energy harvesting device, a power management integrated circuit, an energy storage device, and a low-power electronic device that is powered by the latter. Other components may be added to the circuitry of the apparatus as needed to satisfy engineering and design demands. In general, the components that make up the harvesting/storing apparatus are of small form factors, preferably the product of thin-film technology, to allow for their discrete inclusion in the construction of a greeting card or its accessory item.

The device used to harvest the “personal energy” is preferably a thin-film thermoelectric generator (TEG) capable of harvesting energy from body heat. Human beings associate the warmth of the body with the life and spirit of a living person or animal, and sharing this warmth is a bonding experience; thus body heat is the preferred source of personal energy to be harvested for the application of the present invention. An example of a TEG that is specialized to micro-energy harvesting from human or animal body heat is the ThermoLife module produced by Thermo Life Energy Company, a division of Perpetua Power Source Technologies of Corvallis, Oreg. in USA.

Other harvesting devices can be used to harvest kinetic energy generated by a person or animal through their voluntary or involuntary movements; piezoelectric, Faraday (electromagnetic generator) and biomechanical devices, for example. Still other harvesting technologies suitable for the present invention are being and will be developed. Stating a preference and listing potential technologies here in this specification does not exclude the use of other energy harvesting technologies nor limit the present invention.

The preferred energy storage device for a personal energy greeting card of the present invention is a thin-film, flexible micro-energy cell (MEC) type battery, such as the THINERGY line produced by Infinite Power Solutions of Littleton, Colo. in USA. These rechargeable batteries are small, wafer thin, and very lightweight; they can fit discretely into a conventional greeting card or its accessory item. In addition, micro-energy cells can be charged quickly with very low-power micro-harvested energy, and have been proven to hold their charge for at least ten years. This means the recipient of a personal energy greeting card can have and hold the personal energy of the sender long after receiving the card, which enhances the experience of the social exchange facilitated by the card for both the sender and the recipient.

The components of the disclosed apparatus may be wholly integral to a personal energy greeting card, wholly integral to an accessory item, or reside partially in a card and partially in the card's accessory item. Also, there may be components in the card and/or its accessory that are not part of the apparatus that harvests, stores and uses the personal energy of a person or animal. For example, a personal energy greeting card could feature LED lights and audio playback; while the LED lights would be powered by harvested personal energy, the audio playback could be powered by the energy stored in a separate battery or capacitor which has been charged conventionally. This would create a type of hybrid personal energy greeting card.

Furthermore, a single personal energy greeting card could comprise more than one type of energy harvesting device. For example, such a card could have a thermoelectric generator to harvest body heat and a piezoelectric device that harvests kinetic energy; the electrical power generated by each could charge a single energy storage device or separate ones. Alternatively, one could charge an energy storage device and the other could directly power an electronic device. These multiple harvesting devices could be comprised wholly in a greeting card, partially in the greeting card and partially in an item accessory to the greeting card, or wholly in an accessory item.

Furthermore, a personal energy greeting card and/or its accessory could feature more than one harvesting, storing and evincing apparatus. For example, a card could have two or more separate apparatus and/or circuitries for harvesting personal energy from two or more separate people and/or animals, each exclusively, to power the same or separate electronic device(s) in the card and/or an accessory item. This would yield a collective personal energy greeting card where each of a number of senders could have his or her own personal energy stored and later evinced separately or together in a single card and/or its accessory or accessories. Also, the energy of more than one person or animal could be harvested and stored in a single energy storage device integral to the card, the accessory, or both.

The personal energy stored in the card or the accessory item of a personal energy greeting card may be harvested firsthand, i.e. from the body of the person who sends the card, or it can be harvested secondhand from another person, an infant child for example; or an animal, such as a pet dog.

An accessory item will be of a design and nature such as to complement design elements and/or the social expression of the greeting card it is associated with. The accessory item can be any item that a greeting card maker thinks will accomplish this task; jewelry, trinkets, toys, ornaments, gift cards and writing instruments seem good candidates. The creative minds employed by card makers will surely think of more items that can fill the role and take advantage of the new genre that personal energy greeting cards create.

An accessory item to a personal energy greeting card will assist in creating a personal energy greeting card, and thus, in fulfillment of the intent and scope of this invention, will comprise at least one or more of the components necessary to harvest, store or use personal energy, as defined above. An item that does not have any components related to the harvesting, storage or use of personal energy cannot be considered an accessory of a personal energy greeting card.

An accessory item may be associated with a greeting card in a variety of packaging means: attached, bound or adhered to the card temporarily or permanently, inserted into a cavity in the card's construction, included in a common package with the card, separately packaged and attached, bound or adhered to the card or its packaging, for example. Or, the accessory item may be associated with a greeting card through intent of marketing; that is, it may be sold separately as an accessory to one particular card or to a line or series of greeting cards that provide the purchaser the option of enhancing and complementing the card or cards' design and/or social expression with the accessory item through the inclusion of harvested personal energy, as defined above.

When using a thermoelectric generator module to harvest body heat from a person, the place or area of the human body from which the personal energy is harvested could be left up to the sender of the personal energy greeting card to decide. The preferred site of harvest is the palm of a person's hand, as the touch of one's hand communicates so much. Still, there are areas of the surface of a warm body that emanate heat more intensely than the palm and so could be considered more suitable harvesting sites. And, there could be areas of the body that are more aesthetically, emotionally or sentimentally relevant to a person or the social expression he or she intends to communicate through a personal energy greeting card that could influence his or her choice of where to harvest personal energy. The same could be true of secondhand harvesting, from another person or from an animal.

Harvesting of personal energy could be accomplished through the use of a wholly separate device, separate of the greeting card or its accessory's components. As a first possible such solution, a separate harvesting device could be sold. The device would be able to harvest energy from the living body of a human being or animal and charge an energy storage device that could be used in personal energy greeting cards exclusively or possibly in a variety of products that also utilize a store of harvested personal energy.

Another separate harvesting option could be a kiosk type harvesting and charging station that is located near the place where personal energy greeting cards are sold. A customer who purchased a personal energy greeting card could have his or her personal energy harvested at this station and receive an energy storage device charged with this energy that could be inserted into a personal energy greeting card or its accessory. When harvesting body heat with this type of kiosk solution, it would be possible to decrease the time it takes to harvest enough energy to charge the card's energy storage device by increasing the surface area of the body from which personal energy is harvested. For example, such a kiosk station could feature a comfortable chair that has arrays of thermoelectric generators (TEG) fitted under its seat and back areas. A customer sitting in the chair could have personal energy harvested from all surface areas of his or her body in contact with the chair. A relatively large amount of personal energy could be harvested in a relatively short period of time in this way, especially if “the cold sides” of the TEG's were cooled with an artificially cooled heat sink.

With this kiosk solution, if the purchased personal energy greeting card had an integral energy storage device that was chargeable by inductive charging, a customer could simply place a purchased card on a surface area of the kiosk, where it would be charged via inductive charging with the energy harvested from the customer through the kiosk's micro-energy harvesting apparatus.

While certain types of electronic devices are mentioned in this disclosure, their mention should not be construed to limit to the type of electronic device that can be powered by the stored harvested energy of a personal energy greeting card and/or its accessory. Electronic devices that produce an output that stimulates one of the five senses are preferred; light, audio, video, vibration, electrical shock, and animation (of physical items) come to mind. Again, the card makers' creative designers will surely come up with new and fascinating ideas in this regard that take advantage of the new personal energy greeting card genre.

Finally, an alternative type of personal energy greeting card has the card serving only as medium of delivery for an energy storage device which is charged with personal energy, as defined above; the personal energy would have been harvested and stored in the energy storage device by a process and apparatus wholly separate of the greeting card itself. The card of this exemplary embodiment could be used to send personal energy to a recipient who owns a device that can accept the energy storage device and use the personal energy stored in it. Such a card would provide means for inclusion of such an energy storage device; and/or, such a card would have thematic design and/or indicia that complement and/or can be complemented by the sharing of harvested personal energy, or suggest the same.

### BRIEF DESCRIPTION OF THE SEVERAL DRAWINGS

FIG. 1 is front view of cardstock before it is folded to create the first exemplary embodiment.

FIG. 2 is a rear view of the same cardstock of FIG. 1.

FIG. 3 illustrates the folding of the cardstock of FIGS. 1 and 2.

FIG. 4 is a front view of an opened two-panel card resulting from the folding of the cardstock of FIGS. 1 and 2.

FIG. 5 is a rear view of the same opened two-panel card of FIG. 4.

FIG. 6 schematically illustrates the first exemplary embodiment's circuitry and component design for the micro-energy harvesting, storage and use of personal energy.

FIG. 7 shows a front and side view of a thin-film thermoelectric generator.

FIG. 8 is a front view of a personal energy greeting card of the first exemplary embodiment standing open to highlight the placement of the thermoelectric generator.

FIG. 9 is a rear view of the same card of FIG. 8, again highlighting the placement of the thermoelectric generator.

FIG. 10 is a flowchart that schematically illustrates sets of operating instructions for the sender and the recipient of a personal energy greeting card of the first exemplary embodiment.

FIG. 11 shows a front view of a two-panel greeting card and a bracelet, the two main components of the second exemplary embodiment of the disclosure, standing separate.

FIG. 12 schematically illustrates the circuitry and component design of the second exemplary embodiment as disposed in the bracelet of FIG. 11.

FIG. 13 shows the card of FIG. 11 standing open with the bracelet of FIG. 11 inserted in the card's right panel.

FIG. 14 illustrates the movement of the bracelet into or out of a grooved holding space in the right panel of the card of FIG. 11.

FIG. 15 is a front view of another two-panel greeting card representative of the second exemplary embodiment with emphasis on the card's graphical and textual theme.

FIG. 16 shows the card of FIG. 15 standing open, again with emphasis on the card's continued graphical and textual theme.

FIG. 17 is a flowchart that schematically illustrates sets of instructions for the sender and the recipient of a personal energy greeting card of the second exemplary embodiment.

### DETAILED DESCRIPTION OF THE EXEMPLARY EMBODIMENTS OF THE DISCLOSURE

In one preferred embodiment, a personal energy greeting card is powered by harvested body heat. The card comprises all components necessary to harvest, store and use the energy harvested from the body heat of a living human being or animal.

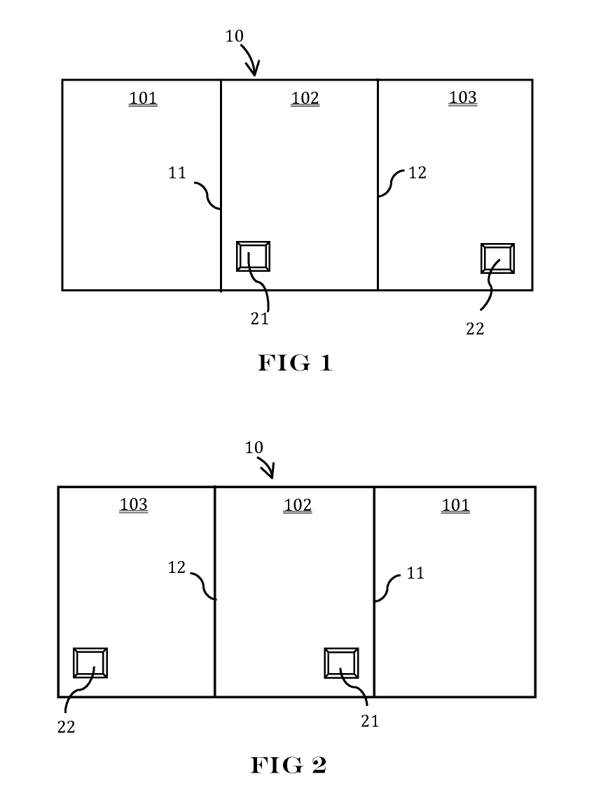

FIGS. 1 and 2 illustrate the way in which the card 10 is folded and cut. The card 10 is generally rectangular in shape. Two folds are made in the card, a left fold 11 and a right fold 12, which yields three panels: a first panel 101, a second panel 102 and a third panel 103, each of the same dimensions.

FIG. 1 shows a view of the front of the card 10 while FIG. 2 shows a rear view of the card 10. In each of these views, the folds 11 and 12 have been made, but the card 10 is unfolded. In both FIG. 1 and FIG. 2, the second panel 102 has a first window 21 cut out of it. In FIG. 1, the front view, the first window 21 is in the lower left hand corner of the second panel 102. In FIG. 2, the rear view, the first window 21 is seen in the lower right hand corner of the second panel 102.

A second window 22 of the same dimensions as the first window 21 is cut out of the third panel 103. In FIG. 1, the front view, the second window 22 is in the lower right hand corner of the third panel 103, while in FIG. 2, the rear view, the second window 22 is seen in the lower left hand corner of the third panel 103.

FIG. 3 illustrates the folding of the card 10 from a front view. The third panel 103 of the card 10 is folded inward and toward the second panel 102, creating a pocket of space 14 between the second panel 102 and the third panel 103. Later, in manufacture, the electrical components of the finished personal energy greeting card of this exemplary embodiment are discreetly packaged in the pocket of space 14, and the outer edges of the third panel 103 are adhered to those of the second panel 102 to seal the pocket of space 14. Of significance, it can be seen from FIG. 3 that when the fold is complete, the second window 22 matches up with the first window 21.

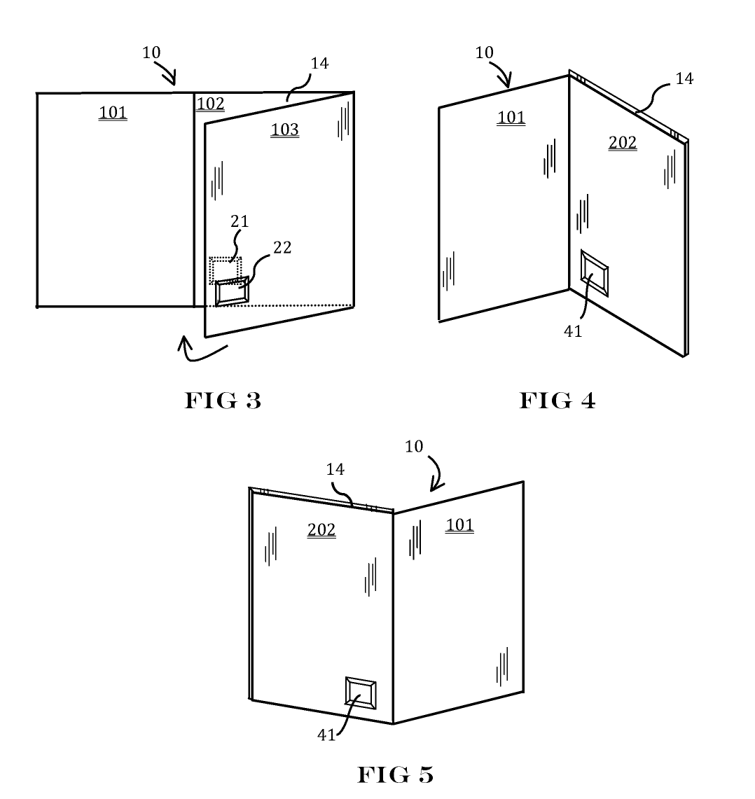

In FIG. 4, the folded card 10 is seen from a front view. The card now has only two panels, a first panel 101 and a newly created two-layered second panel 202. In the newly formed two-layer second panel 202 there is now a merged window 41 in the lower left hand corner that passes through the entire newly formed two-layer second panel 202.

FIG. 5 shows the folded card 10 from a rear perspective. The two-layered second panel 202 is now seen on the left, with the merged window 41 in the lower right hand corner.

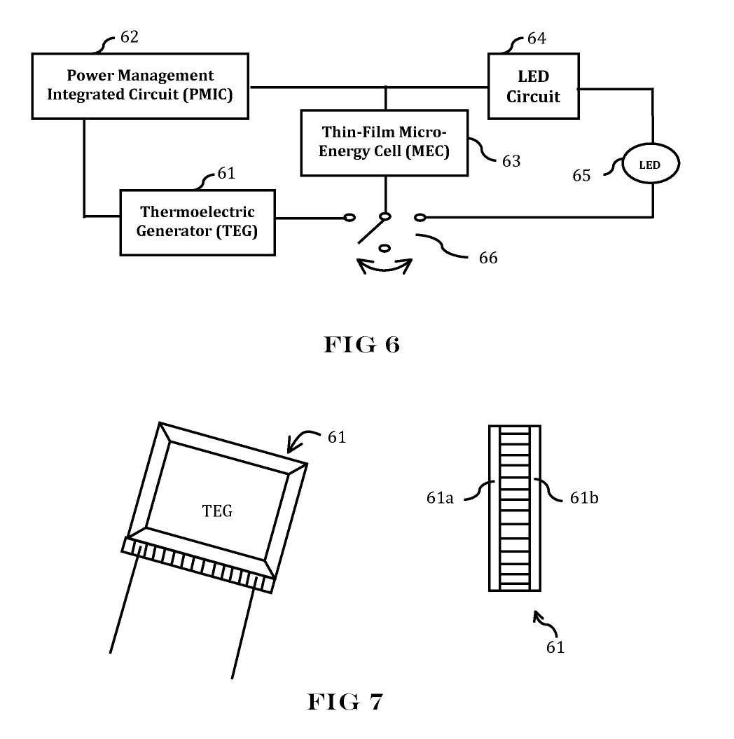

FIG. 6 reveals the internal components and basic circuitry of the exemplary embodiment of a personal energy greeting card that is powered by harvested body heat: a thermoelectric generator (TEG) 61, a power management integrated circuit (PMIC) 62, a rechargeable thin-film micro-energy cell (MEC) 63, an LED circuit 64 with a single LED 65, and a low-profile micro-sized sliding 3-position switch 66. The TEG 61 harvests heat energy from the living body of a person or animal and converts it to electrical energy when the switch 66 is moved to a certain position, outputting the electrical energy to the PMIC 62, which conditions the electrical energy to make it suitable for charging the MEC 63. When charged, the MEC 63 holds a store of “personal energy” that was harvested by the TEG 61 from a person or animal. The MEC 63 powers the LED circuit 64 and ultimately the LED 65 with this stored personal energy when the switch 66 is moved to a certain position; the LED 65 evinces the harvested personal energy through the light it emits when powered by the MEC 63.

All of the components of the circuitry are discreetly disposed in the pocket of space 14. Parts of the LED 65 and the switch 66 protrude from the pocket of space 14 and through the surface of the two-layer second panel 202. Parts of the TEG 61 are exposed through the merged window 41.

The TEG 61 used in this application would be of the thin-film type. Thin-film thermoelectric generators are thin and lightweight, making them suitable for discrete inclusion in a greeting card. Further, the TEG 61 used in this application would be of specifications suited for harvesting heat energy from the living body of a human or animal, where, under normal conditions, there usually exists a small temperature difference between the temperature of the body and its ambient conditions. A good example of such a specialized thermoelectric generator would be the ThermoLife module manufactured by Thermo Life Energy Corporation, a division of Perpetua Power Source Technologies of USA.

In this exemplary embodiment the TEG 61 is a single thermoelectric generator. In other embodiments more than one thermoelectric generator could be used to increase the power generated during the energy harvesting step and reduce the time it takes to harvest enough energy to charge the MEC 63 sufficiently.

Preferably, the PMIC 62 used in this application would be one that is specifically designed for micro-energy harvesting applications, such as the MAX-17710 produced by Maxim Integrated Products of Sunnyvale, Calif. in USA. And the thin-film micro-energy cell (MEC) 63 would be one that is designed specifically for micro-energy harvesting applications, such as the THINERGY rechargeable micro-energy cell produced by Infinite Power Solutions of Littleton, Colo. in USA, which has the added advantages of being “paper thin” and flexible, making it further well-suited for discrete inclusion in a greeting card or its accessory.

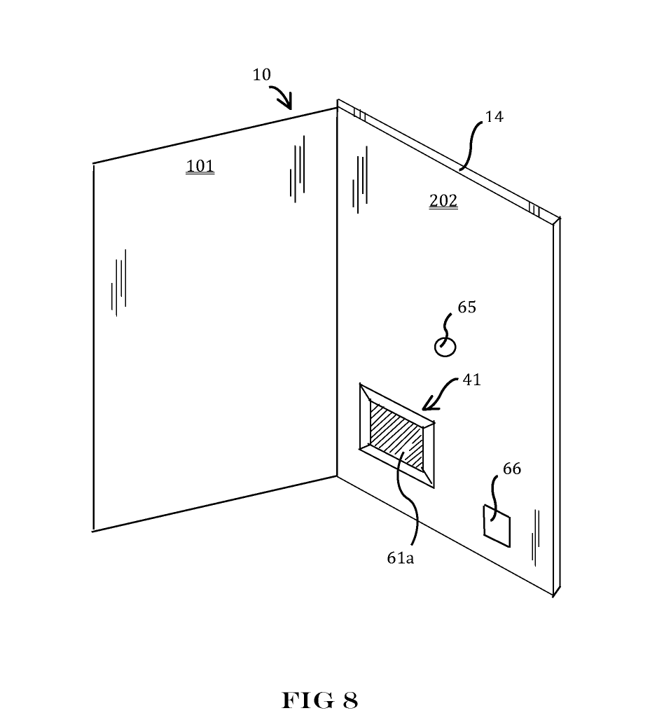

FIG. 7 shows a front and a side view of the TEG 61. Those familiar with thermoelectric generators know that these devices operate on the thermopile principle (Seebeck effect) and have what are commonly referred to as a “hot side” and a “cold side”, and that the devices generate electrical energy when heat flows from the hot side to the cold side. The side view in FIG. 7 identifies these two relevant parts of the TEG 61: the hot side 61a and the cold side 61b. The hot side 61a is the side of the TEG 61 that must be exposed to a heat source, which in this case is the body heat of a person or animal. The cold side 61b is the side that must be exposed to a surface or atmosphere whose temperature is cooler than that of the heat source which the hot side 61a is exposed to in order for the TEG 61 to harvest heat energy and output it in the form of electrical energy.

FIG. 8 shows the card 10 as it would appear in its finished form, standing open to show the interior of the first panel 101 and the two-layered second panel 202. Of interest in FIG. 8 is the interior of the two-layered second panel 202, behind which the previously identified electrical components of the card are discreetly packaged in the pocket of space 14, except for the LED 65 and the switch 66, which are seen in this view on the surface of the two-layered second panel 202. Also, in the lower left hand corner the merged window 41 exposes one side of the TEG 61, which is situated in the pocket of space 14 at the very same spot as the merged window 41. The exposed side identified in FIG. 8 by hatching within the merged window 41 is the “hot side” 61a of the TEG 61.

The dimensions of the merged window 41 are similar to those of the TEG 61, but are slightly smaller in width and length, thereby allowing the TEG 61 to be held in place by the surrounding body of the card 10. That is, the smaller dimensions of the merged window 41 make it possible for the body of the card 10 in this area to cover the outer edges of the TEG 61. In this exemplary embodiment, the TEG's 61 length and width dimensions could be, for example, 1×1 inch square, while the dimensions of the merged window 41 could be ¾×¾ inch square. In manufacture, the TEG 61 could be secured in place at the merged window 41 with an adhesive applied along the TEG's 61 outer edges to adhere it to the overlapping body area of card 10 at the merged window 41.

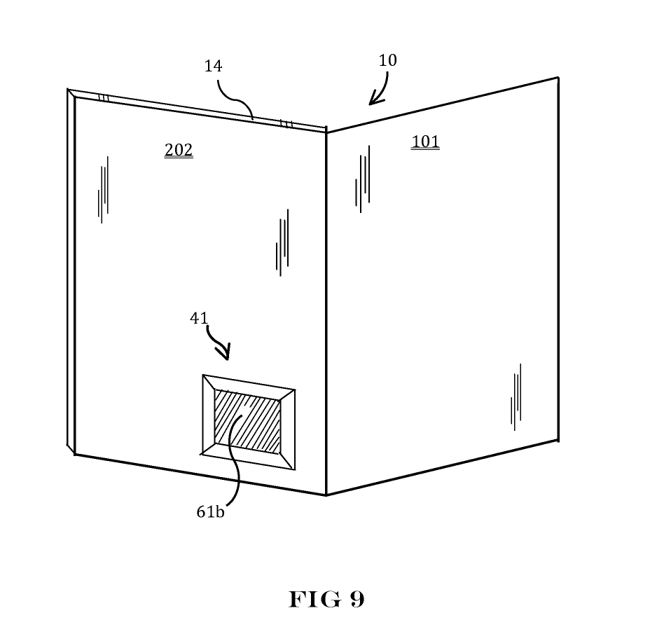

FIG. 9 shows the card 10 from a rear perspective. Of interest in this illustration is the merged window 41 in the lower right hand corner of the two-layer second panel 202, which exposes the “cold side” 61b of the TEG 61. Again the dimensions of the merged window 41 are similar to those of the TEG 61, but are slightly smaller in width and length, thereby allowing the TEG 61 to be held in place by the body of the card 10 in this area.

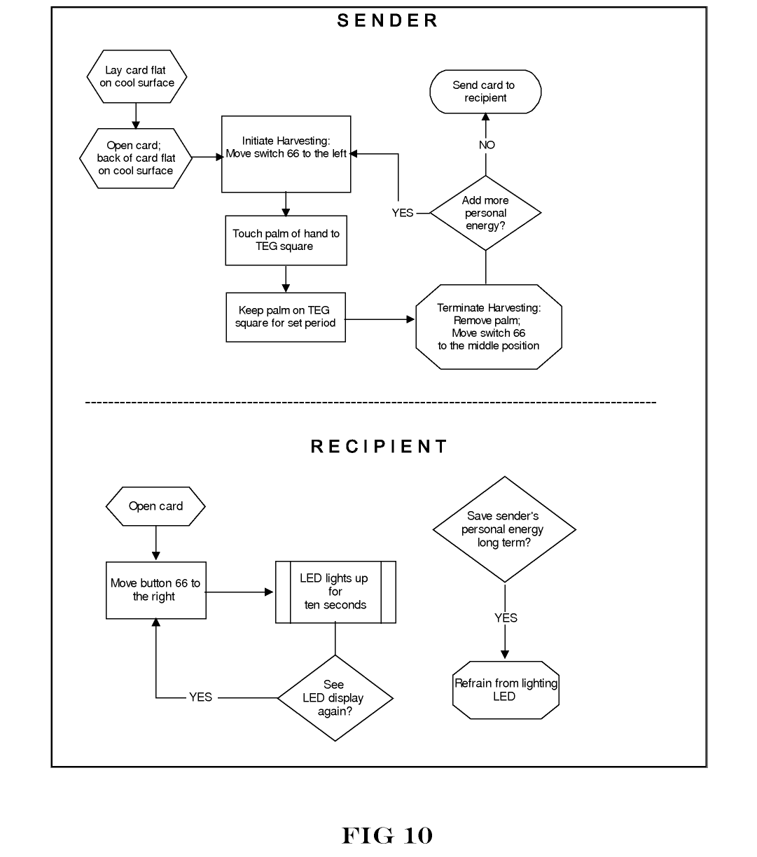

FIG. 10 illustrates through flowcharts the steps the sender of a personal energy greeting card would take to mark the card with his or her personal energy, and the steps the recipient of the card would take to turn on the evincing electronic feature of this exemplary embodiment, the LED 65. It is assumed here that the sender will harvest his or her own body heat. Other steps would be necessary for senders who wanted to harvest body heat secondhand, i.e. from another person or from an animal.

The instructions flowcharted in FIG. 10 have the sender move the sliding switch 66 to the left position when he or she is ready to add his or her personal energy to the card 10. This signals the PMIC 62 to allow electrical energy generated by the TEG 61 to charge the MEC 63. Absent this signal, the PMIC 62 does not allow the MEC 63 to be charged. Acting thus as a gate keeper, the PMIC 62 ensures that the only energy added to the MEC 63 is the personal energy intentionally harvested by the sender of the card 10.

As indicated in FIG. 10, the sender places the card on a cool surface. This exposes the “cold side” (61b) of the card's 10 thermoelectric generator (TEG) 61, to the cool surface. A particularly useful cool surface common to many homes and workplaces is a marble or metal countertop. With ambient room temperature in most homes or offices typically 22-25 degrees Fahreheit lower than the temperature of the average human being, 98.6 Fahrenheit, such surfaces provide enough of a temperature difference and are efficient enough at dissipating heat to serve as makeshift “heat sinks” for the TEG 61. The sender may create a cooler surface artificially by cooling it in a number of ways; this would create better conditions for micro-energy harvesting by providing an even larger temperature difference between the cold side 61b and the hot side 61a during the harvesting step. A tech-savvy sender might use a manufactured heat sink, a device designed specifically for cooling the cold side of a thermoelectric generator to increase its output of electrical energy.

FIG. 10's flowchart indicates that that the sender maintains contact between his or her palm and the cold side 61b of the TEG 61 for a set period of time. In practice, this period of contact would depend on the specifications of the components a manufacturer used to create the card 10, how long or how many times the manufacturer wanted the LED 65 to be playable, and the conditions under which the sender harvested his or her body heat with the personal energy greeting card's 10 thermoelectric generator (TEG) 61.

As an alternative to specifying a period of time for maintaining body contact with the cold side 61b of the TEG 61, a manufacturer of a personal energy greeting card which harvests body heat energy might include a “fuel gauge” in the circuitry that can determine the charge status of the MEC 63 and a means for signaling to the sender when the MEC 63 is sufficiently charged.

After the harvesting step is complete, the sender slides the switch 66 back to the middle position. This signals the PMIC 62 to “close the gate” and not allow further charging of the MEC 63. Finally, the sender can send or give the card 10 to a recipient in the same ways he or she would any conventional greeting card.

Upon receiving the card 10, the recipient can experience the evincement of the sender's personal energy by sliding the switch 66 to the right. This results in the LED 65 using some of the personal energy stored in the MEC 63 to emit light for ten seconds before being shut off automatically by the LED circuit 64. The recipient can choose to enjoy the LED's 65 display repeatedly for as long as there remains a sufficient store of the sender's personal energy in the card's 10 micro-energy cell (MEC) 63. If a recipient wishes to save the sender's personal energy for a long time, he or she should refrain from lighting the LED 65.

In another exemplary embodiment of the personal energy greeting card, a traditional greeting card is associated with a separate but accessory item that can harvest energy from the body of a living human being or animal to power an electronic device of its own. The greeting card serves as a medium for delivery of the accessory item, yet the accessory item complements the social expression of the greeting card and, vice versa, the greeting card's design, graphics, text, etc. complement elements of the accessory item.

FIGS. 11-17 illustrate an alternative embodiment of a personal energy greeting card in which a bracelet is an accessory item that complements the social expression of the card, and in which the harvesting of human or animal body energy is accomplished by components integral to the accessory bracelet.

FIG. 11 features the two primary components of this example of the alternative embodiment: a conventional two-panel greeting card 1200 and a bracelet 1201. There is text 1202 on the front of the card that sets the tone of the social expression of the card 1200. The bracelet 1201 can be made of any material and be of any color or design that serves to complement the social expression or other elements of the greeting card 1200, or vice versa. In this example, the bracelet 1201is made of a flexible, moldable silicon material and is of single construction, having no links or clasps. The bracelet 1201 has three heart-shaped LED's 1203 clustered together at one point along the bracelet's circular length.

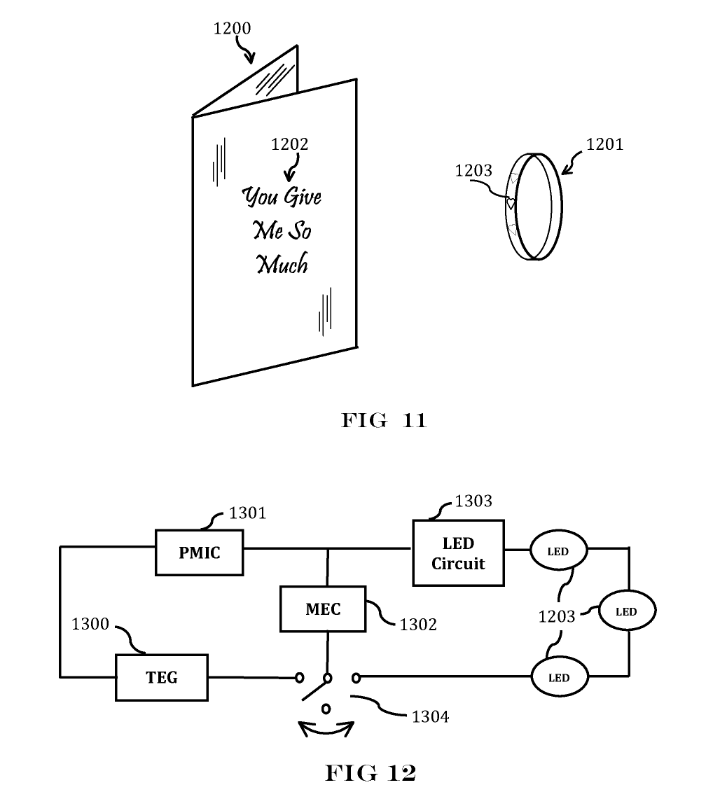

FIG. 12 reveals the electrical components housed within the construction of the bracelet to be similar to those in the previous exemplary embodiment. There is a thin-film thermoelectric generator (TEG) 1300, a power management integrated circuit (PMIC) 1301, a rechargeable micro-energy cell (MEC) 1302, an LED circuit 1303, and a low-profile, micro-sized sliding 3-position switch 1304. The TEG 1300 harvests heat from the body of a person or animal that wears the bracelet and from this harvested heat produces electrical energy. The PMIC 1301 conditions this electrical energy and uses it to charge the thin-film micro-energy cell (MEC) 1302, which powers the bracelet's 1201 three heart-shaped LED's 1203. The action of the LED's 1203 is controlled by an LED circuit 1303. The sliding switch 1304 turns on and off both the harvesting function and the operation of the LED 1203 display when moved to certain positions.

The TEG 1300 in this embodiment needs to be placed at a position along the bracelet 1201 where its so-called hot side can be exposed to the body heat that naturally emanates from the body of the wearer, e.g. on what would be normally considered the inside of the bracelet. In manufacture, the planar surfaces of the TEG 1300 can be left exposed so that they can make direct contact with the body of the wearer on one side (hot side) and the ambient environment on the other (cold side); or, they may be covered with a highly conductive material that would not significantly impede the TEG's 1300 harvesting function, or possibly enhance it. Where a design calls for greater power or more rapid harvesting, more than one thermoelectric generator may be coupled.

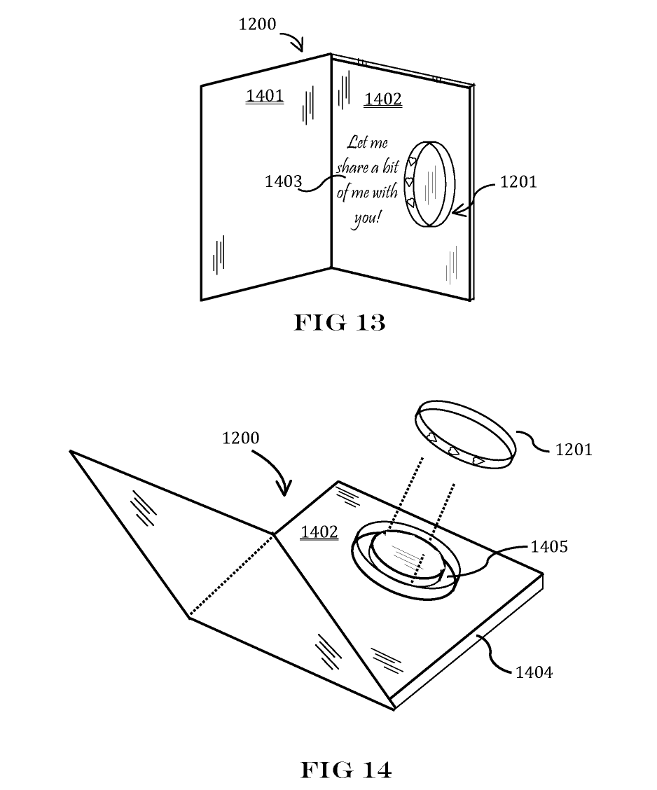

FIG. 13 shows the two-panel card 1200 opened to reveal the inside surfaces of the left panel 1401 and the right panel 1402. The inside surface of the left panel 1401 is free of any text or image so that the sender can add his or her own personal text or image to the card. Of interest in FIG. 13 is the right panel 1402, which is seen here to contain the bracelet 1201 identified first in FIG. 11. There is text 1403 that continues the theme started on the front of the card. Once the sender harvests his or her personal energy and adds it to the bracelet 1201 (by means described below), the bracelet 1201 complements the card's 1200 theme of “giving and sharing of oneself.”

FIG. 14 illustrates the motion of the bracelet 1201 being removed from or placed into the card. FIG. 14 also reveals that the right panel 1402 is thicker than the left panel 1401. In this embodiment, the right panel 1402 is made of a 1-inch thick plastic or foam die cut mold 1404 that has a grooved space 1405 cut out of the surface of the right panel 1402. The grooved space 1405 and the bracelet 1201 are similar enough in dimensions that the bracelet 1201 is held securely within the grooved space 1405 and is flush with or slightly lower than the surface of the right panel 1402; the bracelet 1201 can thus be discreetly packaged with the card 1200 when sold and when given or sent to a recipient.

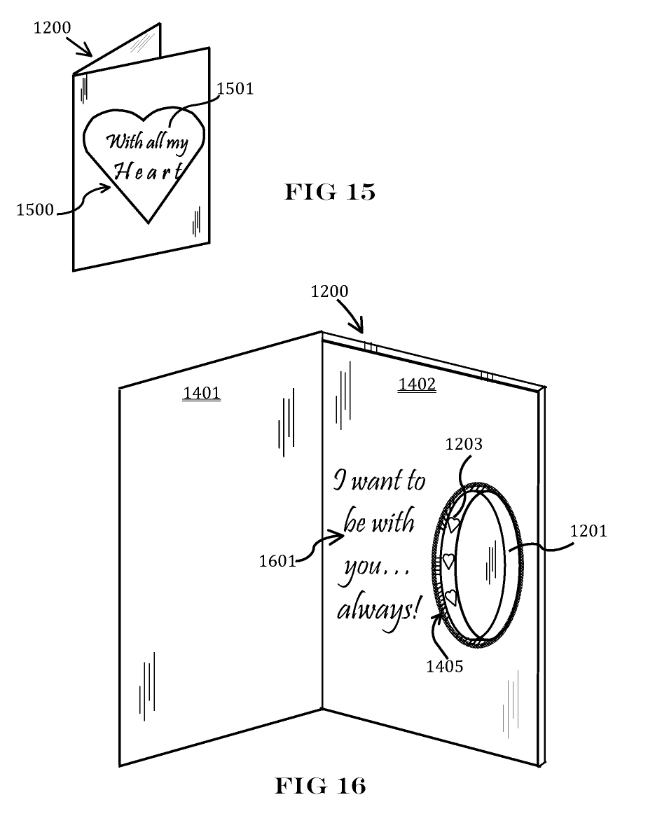

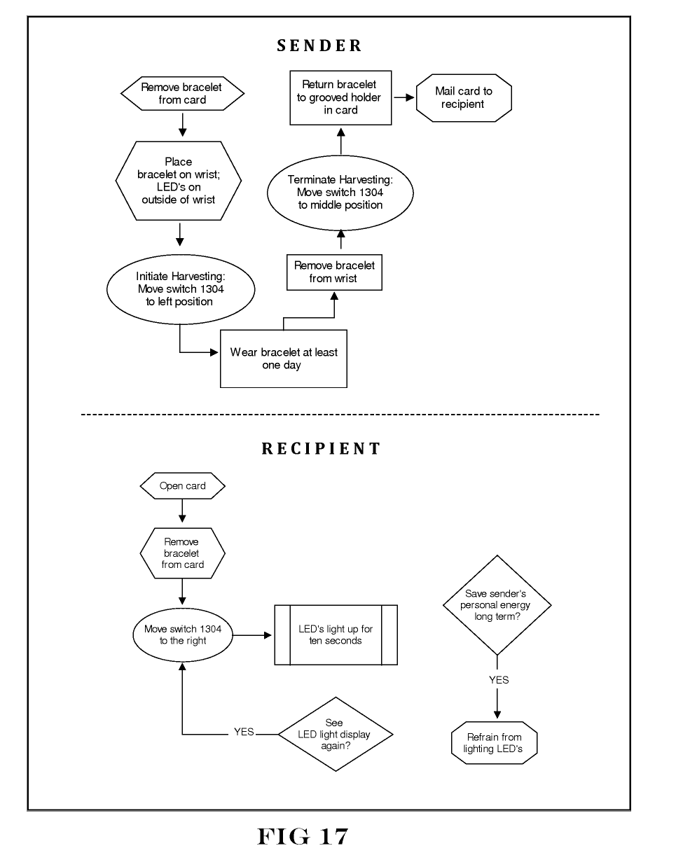

FIGS. 15 and 16 illustrate once more for emphasis how the bracelet 1201 of this embodiment can complement the social expression of the card 1200. In FIG. 15, the theme of the card's social expression is established by the heart-shaped graphic 1500 and the text 1501 “With All My Heart”. In FIG. 16 the bracelet 1201 is shown lifted a bit out of the grooved space 1405 to reveal the bracelet's three heart-shaped LED's 1203. The heart-shaped LED's 1203 complement the cards 1200 “heart theme”. The inside text 1601 printed on the right panel 1402 expresses a heart-felt desire to be with the recipient. Once the sender has added his or her harvested personal energy to the bracelet's 1201 micro-energy cell (MEC) 1302, an intimate part of him/herself is present in the bracelet 1201. Thus, by sending the bracelet 1201 to a recipient as part of the personal energy greeting card 1200 of this exemplary embodiment, the sender is able to fulfill his or her desire, as expressed by the inside text 1601, to be with the recipient, especially should the recipient wear the personal energy greeting card's accessory bracelet 1201.

FIG. 17 is a set of flowcharts that illustrate steps to be taken by the sender and the recipient of the particular personal energy greeting card 1200 of this second exemplary embodiment. It is assumed that the sender will harvest his or her own personal energy to add to the bracelet 1201. As indicated, the sender removes the bracelet from the grooved space 1405 in the right panel 1402 of the card 1200. The sender wears the bracelet 1201 for at least one day, preferably on a wrist, in order to harvest the heat energy generated by his or her body and charge the bracelet's 1201 integral micro-energy cell (MEC) 1302 with a store of his or her personal energy. The sender uses the switch 1304 to both initiate and terminate the harvesting and charging functions of the bracelet's 1201 integral components and circuitry. The sender can ensure, therefore, only energy that he or she has intentionally harvested is added to the bracelet's 1201 integral MEC 1302. When the sender is ready to send or give the personal energy greeting card of this exemplary embodiment to a recipient, he or she places the bracelet back into the grooved space 1405 to secure it in the card 1200.

The recipient of the greeting card 1200 of this embodiment removes the bracelet 1201 from the grooved space 1405. He or she may then enjoy a display of the three heart-shaped LED's 1203 and wear the bracelet 1201 as a reminder of the sender and the social expression he or she sent through the personal energy greeting card 1200, of which the bracelet 1201 is an extension. Because the preferred micro-energy cell (MEC) 1302 of this exemplary embodiment is capable of maintaining its store of energy for a decade or longer, the recipient can have and hold the sender's energy in the bracelet 1201 for many years by refraining from powering the LED's 1203 other than occasionally.

Preferred embodiments of the present invention have been shown. With the abovementioned depictions serving to represent and exemplify, it would be appreciated by those skilled in the art that these depictions are made by way of example only, that the invention is not limited to the particular embodiments described in this disclosure, and that various adaptations, changes, configurations, and substitutions may be made in any practical application of the present invention without departing from the principles and spirit of the exemplary embodiments nor the scope of the invention as hereinafter claimed.

1-17. (canceled)

18-37. (canceled)

38. A method for personalizing a greeting card by associating the greeting card with a store of energy harvested from the living body or bodies of one or more human beings and/or animals who are relevant to the intended social expression of the greeting card, the method comprising in any operative order at least the steps, carried out solely by one party or by a number of contributing parties, of:
providing a greeting card;
providing a chargeable energy storage device;
providing an energy harvesting device capable of harvesting energy from the living body of a person or animal to produce an output of electrical power;
charging the said chargeable energy storage device with the electrical power generated by the said energy harvesting device, wherein the energy harvesting device generates said electrical power by harvesting energy from the living body or bodies of one or more human beings and/or animals who are relevant to the social expression of the greeting card and converting said energy to said electrical power; and
comprising the chargeable energy storage device in or otherwise associating it with the greeting card.

39. The method of claim 38, wherein the greeting card comprises an electronic device capable of producing or causing to be ultimately produced an output that stimulates one or more human senses, and wherein the chargeable energy storage device is placed in direct or indirect detachable operative connection with the said electronic device such that the electronic device can be selectively powered by the chargeable energy storage device after the chargeable energy storage device has been sufficiently charged in the manner specified.

40. The method of claim 39, wherein the greeting card further comprises the said chargeable energy storage device, wherein the chargeable energy storage device is directly or indirectly operatively connected to the electronic device such that the electronic device can be selectively powered by the chargeable energy storage device after the chargeable energy storage device has been sufficiently charged in the manner specified.

41. The method of claim 40, wherein the greeting card further comprises the said energy harvesting device, wherein the energy harvesting device is directly or indirectly electrically connected to the chargeable energy storage device and thus capable of charging the chargeable energy storage device.

42. The method of claim 38, wherein the greeting card is part of a greeting card system that includes at least the greeting card and an accessory item, with the accessory item comprising at least:
an electronic device capable of producing or causing to be ultimately produced an output that stimulates one or more human senses; and
the chargeable energy storage device, wherein the chargeable energy storage device is directly or indirectly operatively connected to the electronic device such that the said electronic device can be selectively powered by the chargeable energy storage device after the chargeable energy storage device has been sufficiently charged in the manner specified.

43. The method of claim 42, wherein the accessory item further comprises the said energy harvesting device, wherein the energy harvesting device is directly or indirectly electrically connected to and thus capable of charging the chargeable energy storage device.

44. The method of claim 38, wherein the chargeable energy storage device is secured in, on or with the greeting card in any suitable manner.

45. The method of claim 38, wherein the greeting card and the chargeable energy storage device are components of the same greeting card product or system.

46. The method of claim 38, wherein the greeting card is additionally personalized in another or other preceding or subsequent ways.

47. The method of claim 38, wherein some of the steps are carried out more than once by one or more parties.

48. The method of claim 38, wherein the chargeable energy storage device is discharged to the maximum extent possible prior to it being charged so that the chargeable energy storage device can be intentionally charged as exclusively as possible with energy harvested from the living body or bodies of only the said one or more human beings and/or animals with whose harvested energy a user wishes to associate and personalize the greeting card.

49. The method of claim 38, wherein the flow of electrical power from the energy harvesting device to the chargeable energy storage device can be selectably enabled or disabled so that a user can control precisely when and the conditions under which the chargeable energy storage device is charged by the electrical output of the energy harvesting device and thus ensure that the chargeable energy storage device is charged as exclusively as possible with energy harvested from only the one or more human beings and/or animals whose store of harvested energy the user intends to associate the greeting card with, and only at a time and under conditions the user wishes.

50. A greeting card system comprising a greeting card and the additional components of:
a chargeable energy storage device; and
an electronic device capable of producing, or causing to be ultimately produced, an output that stimulates one or more human senses, wherein the electronic device is powered by the chargeable energy storage device and wherein the chargeable energy storage device is charged with electrical power generated by and provided from an energy harvesting device, the energy harvesting device generating said electrical power by harvesting energy from the living body or bodies of one or more human beings and/or animals who are relevant to the intended social expression of the greeting card and converting said energy to said electrical power.

51. The greeting card system of claim 50, wherein the greeting card serves as a medium for conveying from a sender to a recipient the store of energy comprised in the chargeable energy storage device after it has been charged in the manner specified.

52. The greeting card system of claim 51, wherein the greeting card's social expression is intended to be complemented and/or enhanced by its association with the said store of energy.

53. The greeting card system of claim 50, wherein the additional components may alternatively be comprised in the greeting card, be comprised in a separate item or items that are accessory to the greeting card, be standalone components, or be disposed in any combination thereof.

54. The greeting card system of claim 50, wherein the greeting card system further comprises the additional component of an energy harvesting device capable of harvesting energy from the living body of a person or animal to produce an output of electrical power, and wherein the chargeable energy storage device is charged with electrical power generated by and provided from the energy harvesting device, the energy harvesting device generating said electrical power by harvesting energy from the living body or bodies of one or more human beings and/or animals who are relevant to the social expression of the greeting card and converting said energy to said electrical power.

55. The greeting card system of claim 54, wherein the additional components may alternatively be comprised in the greeting card, be comprised in a separate item or items that are accessory to the greeting card, be standalone components, or be disposed in any combination thereof.

56. The method of personalizing a greeting card by intentionally associating the greeting card directly or indirectly with a store of energy harvested from the living body or bodies of one or more human beings and/or animals who are relevant to the intended social expression of the greeting card.
